(19) United States
(12) Patent Application Publication
(10) Pub. No.: US 2026/0153417 A1
(43) Pub. Date: Jun. 4, 2026

(54) MULTIPLE BIOMARKER COLLECTION DEVICE

(71) Applicant: 3ID LLC, Scottsdale, AZ (US)

(72) Inventor: Michael Scott WAGNER, Scottsdale, AZ (US)

(21) Appl. No.: 19/073,957

(22) Filed: Mar. 7, 2025

Related U.S. Application Data
(60) Provisional application No. 63/727,657, filed on Dec. 3, 2024.

(51) Int. Cl. G01N 1/36; A61C 9/00

(52) U.S. Cl. CPC G01N 1/36; A61C 9/0006; G01N 2001/366

(57) ABSTRACT

A device for orally collecting multiple biomarkers of a subject includes one or more plates composed of a thermoplastic or other impression material that softens at a temperature of about 150 deg F. and hardens to complete rigidity at temperatures below about 100 deg F. The plates are shaped to fit in the subject's mouth and receive bite impressions of the teeth in the upper and/or lower jaw. The plates extend out of the mouth and provide a gripping portion that the subject pinches to create fingerprint impressions on the softened plates. A rigid body provides a mounting portion for the plates and a handle portion for a person other than the subject to hold while the samples are being collected. Roughened structures, protrusions, or grooves may be formed in the plates and body in areas that contact the subject's inner cheek surfaces, collecting and retaining saliva and skin cells.

### CROSS-REFERENCE TO RELATED APPLICATIONS

This application is a non-provisional claiming the benefit of priority from U.S. Prov. Pat. App. Ser. No. 63/727,657, entitled “3 ID,” filed on Dec. 3, 2024, and incorporated herein in its entirety by reference.

### FIELD OF INVENTION

The present invention relates to the field of oral devices for biomarker collection, and more particularly to devices that use dental impression plates to collect identifying material.

### BACKGROUND

It is well known that the dental impressions, fingerprints, blood, and saliva of a person, even a child, can be used to identify that person. Thus, “biomarkers” such as these are collected and stored by physicians and various agencies, and can be used to find missing persons, identify human remains, solve crimes, and otherwise verify that a person is present—or not present—at a location. For example, forensic odontology, the branch of dentistry which is concerned with identification of corpses by dental and oral characteristics, often plays a major role in the identification of missing persons and victims of crime and accidents using the characteristics of the victim's teeth, such as through x-rays or other imaging, or solid impressions formed by a person biting down on a recording device or composite material.

In various applications, there is a need for a device that rapidly collects biomarkers from individuals. For example, the collection window may be brief, such as when the individual is a child with little patience for such procedures. In another example, where there is a large number of individuals to be documented, it would be advantageous to use a device that obtains samples quickly. There is also a need, in various applications, to collect multiple different biomarkers from a person; for example, collecting odonological, serological, and fingerprint data allows for the entry of complete records in various forensic registries.

U.S. Pat. No. 7,335,022 describes a dental impression device comprised of a thermoplastic material with a low melting point. When heated (e.g., in water) to about 170 deg F., the material softens enough to deform under bite pressure, and then hardens as it cools, leaving a three-dimensional bite record on the device. This device advantageously also collects saliva (and, potentially, skin cells) contemporaneously with the dental impressions. Since DNA content, as well as other features of saliva, can be used to identify the person, the described device effectively collects a plurality of biomarkers at once. While effective, the device is made entirely of a single “wafer” of impression material, so it is completely malleable when softened and also is susceptible to damage and deformation at higher storage temperatures. A user must be careful not to heat the “handle” of the device along with the rest of the wafer, so as not to contaminate the impression material or lose a controlling grip during use.

### SUMMARY OF THE INVENTION

The present invention overcomes the drawbacks of existing technology for collecting a plurality of biomarkers simultaneously using a single oral device. The device features a low-cost, mass-manufacturable design, improved structural resilience, and additional safety features. The device collects a wider array of biomarkers than comparable known devices, including dental impressions, saliva, skin cells, and fingerprints of the subject. The process of using the device to collect biomarkers from a person is very fast, on the order of about 12 seconds as described herein.

A device in accordance with the present invention may in various embodiments include a body that remains rigid during use of the device. The body has a mount portion that fits within the subject's mouth, the mount portion having a planar top surface and a planar bottom surface opposite the top surface. The body has a handle portion attached to or integral with the mount portion and extending at least one inch proximally from the mount portion. The device includes a first plate disposed on the top surface of the mount portion, the first plate composed of a thermoplastic impression material and having a substantially planar outer surface. The first plate has a mouth portion having dimensions that define a bite area in the outer surface of the first plate, the bite area of the first plate aligning with the subject's teeth in the subject's upper jaw. The first plate has a finger portion integral with the mouth portion and extending proximally from the mouth portion and ending at the handle portion of the body, the finger portion defining a touch area in the outer surface of the first plate.

The device may have a second plate disposed on the bottom surface of the mount portion, the second plate also composed of the thermoplastic impression material and having a substantially planar outer surface. The second plate has a mouth portion having dimensions that define a bite area in the outer surface of the second plate, the bite area of the second plate aligning with the subject's teeth in the subject's lower jaw. The second plate has a finger portion integral with the mouth portion of the second plate and extending proximally from the mouth portion and ending at the handle portion of the body, the finger portion defining a touch area in the outer surface of the second plate. The thermoplastic impression material softens at a temperature of about 170 deg F. to 200 deg F., and hardens to rigidity at a temperature of under 100 deg F.; when the thermoplastic impression material is softened, the first and second plates deform in response to bite and touch pressure applied by the subject, such that the first and second plates record dental impressions in the bite areas and fingerprints in the touch areas. The device may further have a plurality of collection structures formed into the body, the first plate, and the second plate at one or more perimeter locations that contact the inner cheek surfaces of the subject during use of the device, the collection structures configured to receive and retain saliva of the subject. For example, the plurality of collection structures may be a series of uniformly spaced grooves traversing the body, the first plate, and the second plate, the grooves cooperating to form a series of posts that collect saliva and/or scrape skin cells from the inner cheek surfaces.

### DESCRIPTION OF THE DRAWINGS

FIG. 1 is a top view of an example embodiment of a multiple biomarker collection device in accordance with the present disclosure.

FIG. 2 is a bottom view of the example device of FIG. 1.

FIG. 3 is a left side view of the example device of FIG. 1.

FIG. 4 is a right side view of the example device of FIG. 1.

FIG. 5 is a rear view of the example device of FIG. 1.

FIG. 6 is a front view of the example device of FIG. 1.

FIG. 7 is a cross-sectional left side view of the example device of FIG. 1, taken along line 7-7 of FIG. 6.

FIG. 8 is a top view of another example embodiment of a multiple biomarker collection device in accordance with the present disclosure.

FIG. 9 is a bottom view of the example device of FIG. 8.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” “integrated,” and “coupled” and variations thereof are used broadly and encompass both direct and indirect mountings, connections, supports, and couplings. Further, “connected” and “coupled” are not restricted to physical or mechanical connections or couplings. Additional definitions follow.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The present disclosure provides a device for orally collecting a plurality of biomarkers of a subject. The device includes one or more plates of impression material configured to deform under bite pressure, recording an impression of the subject's teeth. The plate(s) thus have a shape and size so that all of the subject's upper and/or lower teeth contact the outer surface(s) of a corresponding plate. In some examples, a plate can have a D-shape or a U-shape. The impression material may be a conformal thermoplastic that is rigid at operating temperature and, when heated to around 170 deg F., softens sufficiently so that a normal person can bite down on and deform the plate, the plate then hardening to create an impression of the teeth. One or more of the plates may each have, in addition to a portion that receives the bite, a portion that the subject grasps with one or more fingers. This portion, when softened as above, records the subject's fingerprints as the subject holds the device.

The one or more plates are mounted on a body made of substantially rigid plastic or another suitable material for providing structural support to the plates; that is, the body does not deform responsive to bite pressure. The body may include a mounting portion that receives the plates; in one embodiment, a first plate is disposed on a top surface of the mounting portion and a second plate is disposed on an opposing, or bottom surface of the body. The body may have a handle extending away from the mounting portion. The subject or a second person, such as an administrator of the collection procedure, may grasp the handle during heating of the plates and also during the bite recordation process. Thus, the administrator does not have to touch the impression plates at all, and the subject does not have to touch the plates except to record the fingerprints.

The device may include one or more structures for capturing and retaining saliva as well as exfoliated cheek cells from inside the subject's mouth. The structures may be disposed on the periphery of the portion that enters the subject's mouth, at locations that are likely to contact saliva and soft tissue, such as the inner surfaces of the subject's cheeks. In some embodiments, the structures may be a series of posts either projecting from or formed into certain edges of the device. The structures may be formed into the body, the plate(s), or both.

In an example use of the device: holding the handle, an administrator submerges the plate(s) entirely in boiling or near-boiling water for a few (e.g., 5-15) seconds, until the plate(s) temperature is about 170 deg F.; the administrator withdraws the device from the water and places it in the subject's mouth; the subject grasps the finger portion(s) of the plate(s) and bites down on the device; after two to three seconds, the subject opens the subject's mouth and the administrator extracts the device. The device can be stored in an appropriate hard container (e.g., a specially-designed case) or a soft container (e.g., a plastic bag) to retain a means of physical (dental impressions and fingerprints), chemical (scent of saliva) and biological (DNA) identification of the user, should such be necessary in the future.

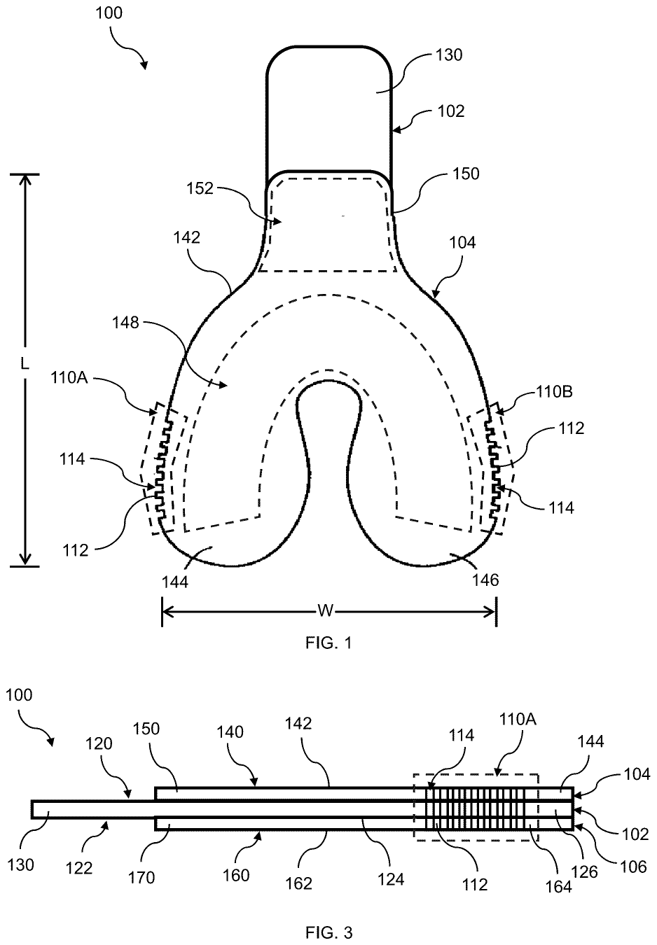

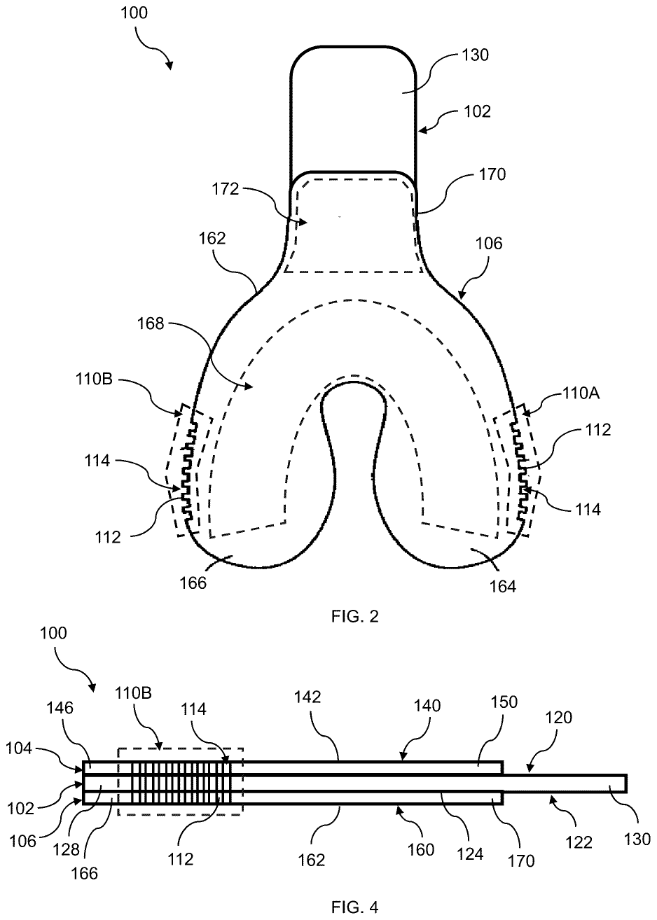

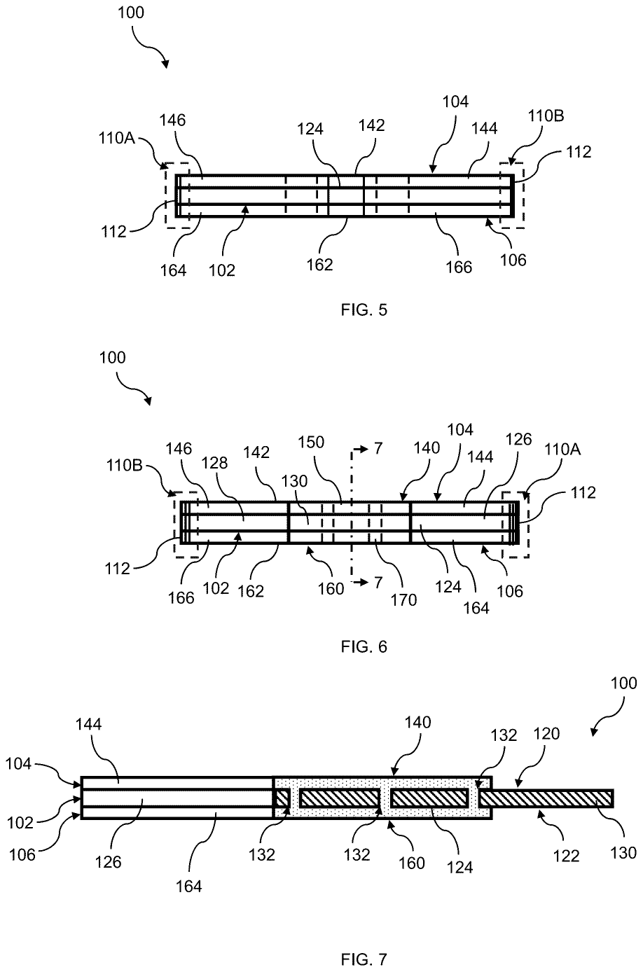

Referring to FIGS. 1-7, an example embodiment is shown of a device 100 that, in accordance with the present disclosure, can be used to rapidly and simultaneously collect and preserve a subject's dental impressions, fingerprints, saliva, and skin cells. The device 100 includes a substantially rigid body 102 supporting one or more plates 104, 106 of impression material mounted thereto. In various embodiments, the body 102 may be a single piece or a plurality of integral or interconnected pieces of rigid plastic. By “rigid,” it is meant that the body 102 is resistant to flexion and can be used to stabilize the device 100 during use, i.e., when a person is handling and/or biting down on the device 100 as described herein. Additionally, the material of the body 102 may have a sufficiently high melting point to remain solid and to not soften at the softening temperatures (e.g., 170 deg F. to 200 deg F., and up to 212 deg F. or more) of the plate 104 material. In some embodiments, the body 102 may be substantially planar, with a first outer surface 120 and a second outer surface 122 of the body 102 that opposes the first outer surface 120 (e.g., top and bottom surfaces of the body 102) lying in parallel planes. In various embodiments, the body 102 may have uniform or varying thickness. In the illustrated embodiment, the body 102 has a uniform thickness of between 1 mm and 3 mm, and more specifically about 2 mm, which thickness combined with the rigidity of the material allows the body 102 to maintain its shape throughout use.

The body 102 may include a mount portion 124 to which plate(s) 104, 106 are mounted. The mount portion 124 is configured to enter the subject's mouth and to be disposed between the teeth of the upper and lower jaw, also extending out of the subject's mouth a sufficient distance to support the plate(s) 104, 106 as described herein. The planar dimensions (i.e., width W and length L) of the mount portion 124 may be selected based on the intended use of the device 100 with either adult or child subjects. Example dimensions for an adult device 100 include a width W of 2.6 to 3.3 inches, and preferably 3 inches, and a length L of 3 to 3.5 inches, and preferably 3.25 inches; example dimensions for a child device 100 include a width W of 2 to 2.5 inches, and preferably 2.25 inches, and a length L of 2.5 to 3 inches, and preferably 2.75 inches. The mount portion 124 may have a D-shape, or a U-shape that allows the subject's tongue to traverse the device 100 vertically, or another suitable shape that positions the plate(s) 104, 106 to receive the tooth impressions. For example, as illustrated, a U-shaped mount portion 124 may have a first lobe 126 extending posteriorly along one side of the jaw and a second lobe 128 extending posteriorly along the other side of the jaw. In one example, the device 100 may include a single plate 104 for collecting the dental impressions of the teeth in either the upper jaw or the lower jaw, as well as at least one fingerprint in accordance with this disclosure. Preferably, the device 100 records impressions of all of the subject's teeth, and therefore includes a first plate 104 mounted to the first outer surface 120 at the mount portion 124, and a second plate 106 mounted to the second outer surface 122 at the mount portion 124.

The body 102 further includes a handle portion 130 attached to or integral with the mount portion 124 and extending outward, or anterior to the subject. The handle portion 130 extends a sufficient length to be firmly grasped by a user of the device 100 without contacting the plates 104, 106. In some embodiments, the handle portion 130 is between one inch and three inches long, and up to five inches long. The handle portion 130 further enables the user to hold the device 100 as the plates 104, 106 are heated. For example, the device 100 may be held by the handle portion 130 while the plates 104, 106 are submerged vertically in a vessel of very hot water until softened, as described further below. Another advantage of the handle portion 130 is it allows an administrator using the device 100 to collect biomarkers from a subject to maintain control of the device 100 while keeping a safe distance between the administrator's fingers and the subject's teeth, by grasping the handle portion 130 near the proximal end of the device 100 during sample collection.

Each plate 104, 106 of the device 100 may be comprised of a single piece or a plurality of integral, interconnected, or cooperatively-situated pieces of impression material. The impression material may be any material that is suitable to i) collect both dental impressions and fingerprint impressions, and ii) reliably preserve the impressions after collection. Various suitable materials are known in the dental industry, including wax compositions, elastomeric molding compounds (e.g., alginate, polyether, polyvinyl siloxane and other silicone-based compounds), and thermoplastic materials. In one example the plates 104, 106 are comprised of ROLYAN POLYFORM conforming thermoplastic material or a similar thermoplastic material that softens at a temperature of 150 deg F. to 200 deg F., and particularly about 170 deg F., and hardens as it cools. Each plate 104, 106 may be substantially planar, and may have a sufficient thickness to accurately record the details of the bite surfaces of a subject's teeth. For example, plate thickness is at least one millimeter, and preferably about 1.5 mm. An example total thickness of the device 100 including a body 102 and two plates 104, 106 of the same thickness is therefore between four and seven millimeters, and more specifically about five millimeters. The planar dimensions (i.e., width W and length L) of each plate 104, 106 may be selected based on the intended use of the device 100 with either adult or child subjects. Example dimensions for an adult device 100 include a width W of 2.6 to 3.3 inches, and preferably 3 inches, and a length L of 3 to 3.5 inches, and preferably 3.25 inches; example dimensions for a child device 100 include a width W of 2 to 2.5 inches, and preferably 2.25 inches, and a length L of 2.5 to 3 inches, and preferably 2.75 inches.

The first plate 104 may be adhered, bonded (e.g., by thermal weld), or otherwise firmly, and preferably non-removably, attached to the external first surface 120 of body 102 on the mount portion 124. In some embodiments, the first plate 104 may be die-cut from a block of impression material, and then glued using a medical-grade adhesive to the first surface 120 of the body 102 on the mount portion 124. The first plate 104 may have a planar inner surface (not shown) that contacts the body 102, so that a planar outer surface 140 of the first plate 104, opposing the inner surface, is positioned to contact the subject's teeth and fingertips. The first plate 104 includes a mouth portion 142 configured to enter the subject's mouth and to be disposed between the teeth of the upper and lower jaw. The mouth portion 142 may have a D-shape, or a U-shape that allows the subject's tongue to traverse the device 100 vertically, or another suitable shape that positions the first plate 104 to receive the tooth impressions. In some embodiments, the shape of the mouth portion 142 may conform to the shape of that part of the mount portion 124 that enters the subject's mouth. For example, as illustrated, a U-shaped mouth portion 142 may have a first lobe 144 extending posteriorly along one side of the jaw and a second lobe 146 extending posteriorly along the other side of the jaw, the lobes 144, 146 of the mouth portion 142 having the same perimeter as the lobes 126, 128 of the mount portion 124. The shape of the mouth portion 142 provides an arcuate bite area 148 on the outer surface 140 of the first plate 104; the subject's teeth (i.e., the teeth of the upper jaw) will deform the outer surface 140 within the bite area 148 when the subject bites the softened first plate 104.

The first plate 104 further includes a finger portion 150 attached to, abutting, adjacent to, or integral with the mouth portion 142. The finger portion 150 extends outward, or anterior to the subject, from the mouth portion 142, so that the finger portion 150 is disposed outside of the subject's mouth. The finger portion 150 may be one inch or longer in length, and one inch or longer in width, but in any case is sized to receive a complete fingerprint from the index or middle finger of the subject within a touch area 152 on the outer surface 140 of the first plate 104; when the subject is instructed to pinch the device 100 at the finger portion 150, the subject's fingertip will deform the outer surface 140 within the touch area 152 when the subject pinches the softened first plate 104.

In similar fashion, the second plate 106 may be adhered, bonded (e.g., by thermal weld), or otherwise firmly, and preferably non-removably, attached to the external second surface 122 of the body 102 on the mount portion 124. The second plate 106 may have a planar inner surface (not shown) that contacts the body 102, so that a planar outer surface 160 of the second plate 106, opposing the inner surface, is positioned to contact the subject's teeth and fingertips. In some embodiments, the second plate 106 may be die-cut or otherwise fashioned from a block of impression material (either the same block as the first plate 104 or a different block), and then glued using a medical-grade adhesive to the second surface 122 of the body 102 on the mount portion 124. In other embodiments, the plate(s) 104, 106 may be injection molded or otherwise deposited onto the body 102 when the thermoplastic impression material is in a softened or molten state. As shown in the cross-section of FIG. 7, the mount portion 124 of the body 102 may comprise a plurality of through-holes 132 connecting the opposing surfaces 120, 122 on which the respective plates 104, 106 are disposed; the plates 104, 106 may be formed in situ on the body by depositing the impression material, in its malleable state, onto the body 102 so that the impression material flows through the through-holes 132 as it is injected or flattened to create the planar outer surfaces 140, 160 of the plates 104, 106. The material within the through-holes 132 contacts both plates 104, 106 and becomes integral with both plates 104, 106 as the impression material cools and hardens. The plates 104, 106 are thus bonded to each other, in place on the body 102, through the through-holes 132.

Referring again to FIGS. 1-7, the second plate 106 includes a mouth portion 162 configured to enter the subject's mouth and to be disposed between the teeth of the upper and lower jaw. The mouth portion 162 may have a D-shape, or a U-shape that allows the subject's tongue to traverse the device 100 vertically, or another suitable shape that positions the second plate 106 to receive the tooth impressions. In some embodiments, the shape of the mouth portion 162 may conform to the shape of that part of the mount portion 124 that enters the subject's mouth; additionally, or alternatively, the shape of the mouth portion 162 may conform to the shape of the mouth portion 142 of the first plate 104. For example, as illustrated, a U-shaped mouth portion 162 may have a first lobe 164 extending posteriorly along one side of the jaw and a second lobe 166 extending posteriorly along the other side of the jaw, the lobes 164, 166 of the mouth portion 162 having the same perimeter as the lobes 126, 128 of the mount portion 124 and the lobes 144, 146 of the first plate 104. The shape of the mouth portion 162 provides an arcuate bite area 168 on the outer surface 160 of the second plate 106; the subject's teeth (i.e., the teeth of the lower jaw) will deform the outer surface 160 within the bite area 168 when the subject bites the softened second plate 106.

The second plate 106 further includes a finger portion 170 attached to, abutting, adjacent to, or integral with the mouth portion 162. The finger portion 170 extends outward, or anterior to the subject, from the mouth portion 162, so that the finger portion 170 is disposed outside of the subject's mouth. The finger portion 170 may be one inch or longer in length, and one inch or longer in width, but in any case is sized to receive a complete fingerprint from the thumb of the subject within a touch area 172 on the outer surface 160 of the second plate 106; when the subject is instructed to pinch the device 100 at the finger portion 170, the subject's thumb will deform the outer surface 160 within the touch area 172 when the subject pinches the softened second plate 106.

The device 100 is further configured to capture saliva and skin cells through contact of the device 100 with the subject's saliva and the inner skin surfaces of the subject's mouth. Within one or more contact areas 110A, 110B of the device 100—that is, location(s) on the perimeter of the device 100 that are likely to come into contact with both saliva and the inner surfaces of the subject's cheek(s)—the device 100 may be roughened, grooved, etched, scored, or otherwise equipped with structures that facilitate capture of saliva and skin cells. In some embodiments, a series of structures may be attached to or formed into the body 102 and/or the plate(s) 104, 106 within one or more of the contact areas 110A, 110B. For example, a plurality of grooves 114 or recesses may be formed into the first plate 104, body 102, and second plate 106, so that each groove 114 extends through the full thickness of the device 100. The grooves 114 may be uniformly or non-uniformly sized and spaced, creating a series of posts 112 separated by the grooves 114 along the perimeter of the device 100 within the contact area(s) 110A, 110B. In this example, as illustrated, the posts 112 remain within the contour of the device 100, but in other embodiments the posts 112 may protrude beyond the contour or may be slightly withdrawn from what would be the contour if such features weren't present. At a size of about 1 mm to 1.5 mm, the grooves 114 and posts 112 cooperate to capture saliva and can also capture loose cells located in the mouth. The posts 112 also typically rub against the inside of the user's cheek, which can further loosen cells from the mucous membrane, which are then captured in the relevant features. As an alternative to forming grooves 114 to create the posts 112, the posts 112 may instead be attached to the lobes of the device 110 so that the posts 112 protrude from respective lobes.

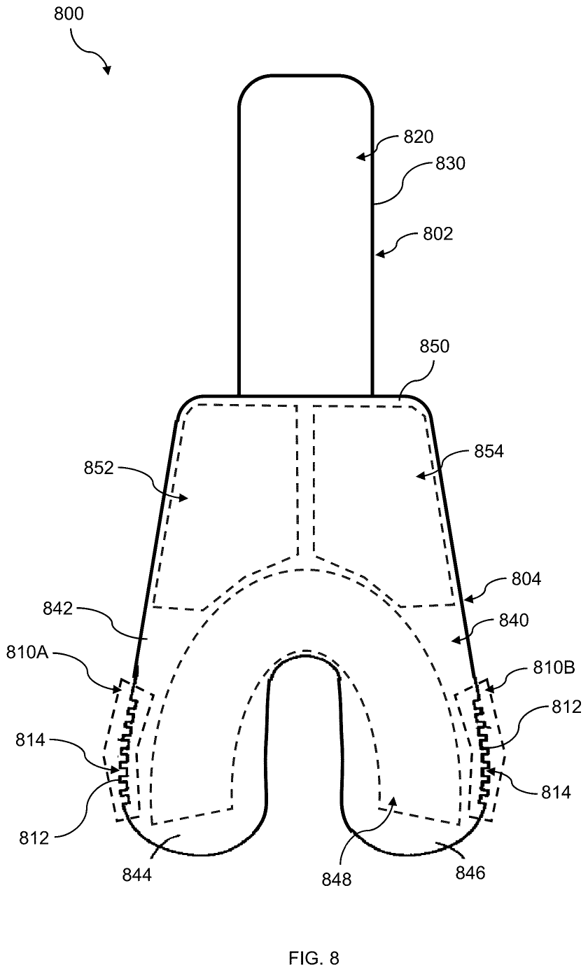

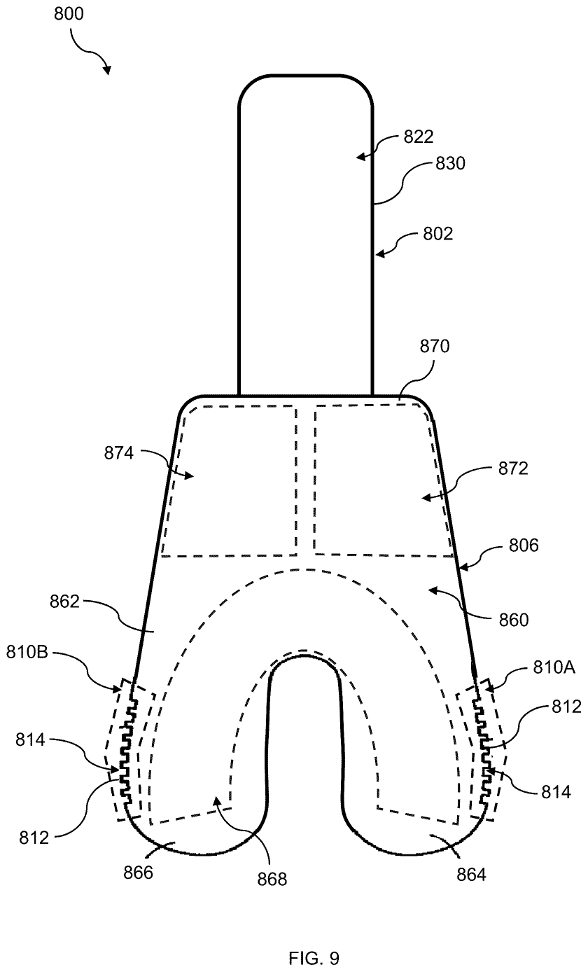

FIGS. 8 and 9 illustrate another example embodiment of a device 800 for collecting multiple biomarkers orally. The device 800 is configured in much the same way as the device 100 described above with respect to FIGS. 1-7, with certain variations of the device 100 features. The body 802 is as described above with respect to the body 102, except that the handle portion 830 is shown with a greater length, specifically three to five inches, as opposed to the one inch length of the handle portion 130 described above. The longer handle portion 830 provides for an increased distance between the fingers, if a person grasps the proximal end of the handle portion 830, and the hot water or the subject's mouth and hands. Plates 804, 806 of the device 800 are similarly configured to the plates 104, 106, including attachment to the outer surfaces 820, 822 of the body 802 and inclusion of a mouth portion 842, 862 that defines a bite area 848, 868 on the outer surface 840, 860 of each plate 804, 806. Additionally, saliva and skin cell collection structures, such as posts 812 and recesses 814, are formed into the device 800 in the contact area(s) 810A, 810B as described above.

The first plate 804 also includes a digit portion 850 that, like the finger portion 150 described above, extends outward from the mouth portion 842. The digit portion 850 is longer and wider than the comparable finger portion 150 of example device 150, and provides two touch areas 852, 854 each sized to receive multiple fingertips of the subject. In an example embodiment, a first touch area 852 is sized to receive all four fingertips of the subject's left hand, and a second touch area 854 is sized to receive all four fingertips of the subject's right hand. Similarly, the second plate 806 includes a thumb portion 870 that is larger than the comparable finger portion 170 of the example device 100; the thumb portion 870 includes a first touch area 872 that receives the subject's left thumb impression onto the outer surface 860, and a second touch area 874 that receives the subject's right thumb impression onto the outer surface 860. In this manner, the device 800 collects all ten fingerprints of the subject, as well as the full dental impression and the saliva and skin cells of the subject.

A suitable thermoplastic material used for the plates can soften in near-boiling water (190 deg F. to 212 deg F.) and harden at the temperature inside the subject's mouth (about 90 deg F. to 95 deg F.) within seconds. Thus, in one method of using the devices disclosed herein, an administrator may prepare for biomarker collection by acquiring an unused device (e.g., stored in a protective bag or wrapper) and a vessel of near-boiling water. The administrator may then: remove the device from its wrapper; holding the device by the handle portion, submerge the plates in the water and hold for 10-15 seconds; withdraw the plates from the water; optionally, allow the device to cool for up to five seconds, so as not to burn the subject; place the mouth portions into the subject's mouth and instruct the subject to bite down; promptly also instruct the subject to pinch the finger portions; wait at least two and up to five seconds for the plates to harden; and, extract the device from the subject's mouth. The device may then be allowed to cool for 30-45 seconds and finally placed in a storage container and labeled accordingly. After collection, if the device is kept in a plastic bag or another airtight container, the saliva will remain a viable source of scent for trained dogs. The saliva and cells can also be used as a source of DNA for identification purposes. The bite impression and fingerprint impressions can also be used for identification purposes.

Therefore, in one aspect, the present disclosure provides a device for collecting a plurality of biomarkers of a subject, the device including: a body that remains rigid during use of the device, the body including a mount portion that fits within the subject's mouth and having a planar top surface and a planar bottom surface opposite the top surface, and a handle portion attached to or integral with the mount portion and extending at least one inch proximally from the mount portion; a first plate disposed on the top surface of the mount portion, the first plate composed of a thermoplastic impression material and having a substantially planar outer surface, a mouth portion having dimensions that define a bite area in the outer surface of the first plate, the bite area of the first plate aligning with the subject's teeth in the subject's upper jaw, and a finger portion integral with the mouth portion of the first plate and extending proximally from the mouth portion and ending at the handle portion of the body, the finger portion defining a touch area in the outer surface of the first plate; and, a second plate disposed on the bottom surface of the mount portion, the second plate composed of the thermoplastic impression material and including a substantially planar outer surface, a mouth portion having dimensions that define a bite area in the outer surface of the second plate, the bite area of the second plate aligning with the subject's teeth in the subject's lower jaw, and a finger portion integral with the mouth portion of the second plate and extending proximally from the mouth portion and ending at the handle portion of the body, the finger portion defining a touch area in the outer surface of the second plate. The thermoplastic impression material softens at a temperature of about 150 deg F. to 200 deg F., and particularly about 170 deg F., and hardens to rigidity at a temperature of under 100 deg F., the first and second plates deforming, when the thermoplastic impression material is softened, in response to bite and touch pressure applied by the subject, such that the first and second plates record dental impressions in the bite areas and fingerprints in the touch areas.

The device may further include a plurality of collection structures formed into the body, the first plate, and the second plate at one or more perimeter locations that contact one or more inner cheek surfaces of the subject during use of the device, the collection structures configured to receive and retain saliva of the subject. The plurality of collection structures may include a series of uniformly spaced grooves traversing the body, the first plate, and the second plate, the grooves cooperating to form a series of posts that scrape skin cells from the one or more inner cheek surfaces.

The handle portion of the body may be between three and five inches long. The touch area of the first plate may be sufficiently large to record fingerprints of all four fingers of a first hand of the subject. The touch area of the finger portion of the first plate may be a first touch area, and the finger portion of the first plate may further define a second touch area adjacent to the first touch area, the second touch area being sufficiently large to record fingerprints of all four fingers of a second hand of the subject.

In another aspect, the present disclosure provides a device for collecting a plurality of biomarkers of a subject, the device including: a substantially rigid body including a mount portion that fits within the subject's mouth, and a handle portion attached to or integral with the mount portion and extending proximally from the mount portion; and, a first plate disposed on a first surface of the mount portion, the first plate composed of an impression material that softens to a deformable state at a first temperature over 100 deg F. and hardens to rigidity at a second temperature under 100 deg F. The first plate has an outer surface that defines: a first bite area aligning with the subject's teeth in the subject's upper or lower jaw, the first plate recording a dental impression of the subject within the first bite area when the first plate is subjected in the deformable state to bite pressure of the subject; and, a first touch area disposed externally to the subject's mouth, the first plate recording one or more fingerprints of the subject within the first touch area when the first plate is subjected in the deformable state to touch pressure of the subject.

The first bite area may align with the teeth in the subject's upper jaw, and the device may further include a second plate disposed on a second surface of the mount portion opposite the first surface. The second plate is composed of the impression material and has an outer surface that defines: a second bite area aligning with the subject's teeth in the subject's lower jaw, the second plate recording the dental impression of the subject within the second bite area when the second plate is subjected in the deformable state to bite pressure of the subject; and, a second touch area disposed externally to the subject's mouth, the second plate recording a fingerprint of a thumb of the subject within the second touch area when the second plate is subjected in the deformable state to touch pressure of the subject.

The impression material may be a thermoplastic material that softens at a temperature of 150 deg F. to 200 deg F., and preferably at about 170 deg F. The device may further include a medical-grade adhesive adhering the first plate to the first surface and the second plate to the second surface. The mount portion of the body may include one or more through-holes, and the thermoplastic material may extend through the one or more through-holes to integrally connect the first plate to the second plate, retaining the first plate against the first surface of the body and the second plate against the second surface of the body.

The device may further include one or more collection areas formed in a perimeter of the device defined by the body, the first plate, and the second plate, the one or more collection areas defining or including structural features that cause saliva of the subject to be retained in the structural features when contacted by the device. The structural features may include a roughened surface of one or more of the first plate, the second plate, and the body, at the perimeter and within the one or more collection areas. The structural features may include a series of uniformly spaced grooves traversing the body, the first plate, and the second plate, the grooves cooperating to form a series of posts that scrape skin cells from the subject's inner cheek.

The first plate may include a mouth portion on which the first bite area is disposed; the second plate may include a mouth portion on which the second bite area is disposed; and, the mount portion of the body, the mouth portion of the first plate, and the mouth portion of the second plate may cooperate to provide the device with a conformal U-shape that fits within the subject's mouth. The first plate may include a finger portion on which the first touch area is disposed, the finger portion integral with the mouth portion of the first plate and extending at least one inch proximally from the mouth portion of the first plate; and, the second plate may include a finger portion on which the second touch area is disposed, the finger portion integral with the mouth portion of the second plate and extending at least one inch proximally from the mouth portion of the second plate. The handle portion of the body may extend at least three inches proximally from the respective finger portions of the first and second plates.

The inventions and methods described herein can be viewed as a whole, or as a number of separate inventions, that can be used independently or mixed and matched as desired. All inventions, steps, processes, devices, and methods described herein can be mixed and matched as desired. All previously described features, functions, or inventions described herein or by reference may be mixed and matched as desired. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A device for collecting a plurality of biomarkers of a subject, the device comprising:
a body that remains rigid during use of the device, the body comprising:
a mount portion that fits within the subject's mouth, the mount portion having a planar top surface and a planar bottom surface opposite the top surface; and
a handle portion attached to or integral with the mount portion and extending at least one inch proximally from the mount portion;
a first plate disposed on the top surface of the mount portion, the first plate composed of a thermoplastic impression material and comprising:
a substantially planar outer surface;
a mouth portion having dimensions that define a bite area in the outer surface of the first plate, the bite area of the first plate aligning with the subject's teeth in the subject's upper jaw; and
a finger portion integral with the mouth portion of the first plate and extending proximally from the mouth portion and ending at the handle portion of the body, the finger portion defining a touch area in the outer surface of the first plate; and
a second plate disposed on the bottom surface of the mount portion, the second plate composed of the thermoplastic impression material and comprising:
a substantially planar outer surface;
a mouth portion having dimensions that define a bite area in the outer surface of the second plate, the bite area of the second plate aligning with the subject's teeth in the subject's lower jaw; and
a finger portion integral with the mouth portion of the second plate and extending proximally from the mouth portion and ending at the handle portion of the body, the finger portion defining a touch area in the outer surface of the second plate;
wherein the thermoplastic impression material softens at a temperature of about 170 deg F. and hardens to rigidity at a temperature of under 100 deg F., the first and second plates deforming, when the thermoplastic impression material is softened, in response to bite and touch pressure applied by the subject, such that the first and second plates record dental impressions in the bite areas and fingerprints in the touch areas.

2. The device of claim 1, further comprising a plurality of collection structures formed into the body, the first plate, and the second plate at one or more perimeter locations that contact one or more inner cheek surfaces of the subject during use of the device, the collection structures configured to receive and retain saliva of the subject.

3. The device of claim 2, wherein the plurality of collection structures comprises a series of uniformly spaced grooves traversing the body, the first plate, and the second plate, the grooves cooperating to form a series of posts that scrape skin cells from the one or more inner cheek surfaces.

4. The device of claim 1, wherein the handle portion is between three and five inches long.

5. The device of claim 1, wherein the touch area of the first plate is sufficiently large to record fingerprints of all four fingers of a first hand of the subject.

6. The device of claim 5, wherein the touch area of the finger portion of the first plate is a first touch area, and the finger portion of the first plate further defines a second touch area adjacent to the first touch area, the second touch area being sufficiently large to record fingerprints of all four fingers of a second hand of the subject.

7. A device for collecting a plurality of biomarkers of a subject, the device comprising:
a substantially rigid body comprising:
a mount portion that fits within the subject's mouth; and
a handle portion attached to or integral with the mount portion and extending proximally from the mount portion; and
a first plate disposed on a first surface of the mount portion, the first plate composed of an impression material that softens to a deformable state at a first temperature over 100 deg F. and hardens to rigidity at a second temperature under 100 deg F., the first plate having an outer surface that defines:
a first bite area aligning with the subject's teeth in the subject's upper or lower jaw, the first plate recording a dental impression of the subject within the first bite area when the first plate is subjected in the deformable state to bite pressure of the subject; and
a first touch area disposed externally to the subject's mouth, the first plate recording one or more fingerprints of the subject within the first touch area when the first plate is subjected in the deformable state to touch pressure of the subject.

8. The device of claim 7, further comprising one or more collection areas formed in a perimeter of the device defined by the body and the first plate, the one or more collection areas comprising structural features that cause saliva of the subject to be retained in the structural features when contacted by the device.

9. The device of claim 7, wherein the first bite area aligns with the teeth in the subject's upper jaw, the device further comprising a second plate disposed on a second surface of the mount portion opposite the first surface, the second plate composed of the impression material and having an outer surface that defines:
a second bite area aligning with the subject's teeth in the subject's lower jaw, the second plate recording the dental impression of the subject within the second bite area when the second plate is subjected in the deformable state to bite pressure of the subject; and
a second touch area disposed externally to the subject's mouth, the second plate recording a fingerprint of a thumb of the subject within the second touch area when the second plate is subjected in the deformable state to touch pressure of the subject.

10. The device of claim 9, wherein the impression material is a thermoplastic material that softens at a temperature of 150 deg F. to 170 deg F.

11. The device of claim 10, further comprising a medical-grade adhesive adhering the first plate to the first surface and the second plate to the second surface.

12. The device of claim 10, wherein:
the mount portion of the body comprises one or more through-holes; and
the thermoplastic material extends through the one or more through-holes to integrally connect the first plate to the second plate, retaining the first plate against the first surface of the body and the second plate against the second surface of the body.

13. The device of claim 10, further comprising one or more collection areas formed in a perimeter of the device defined by the body, the first plate, and the second plate, the one or more collection areas comprising structural features that cause saliva of the subject to be retained in the structural features when contacted by the device.

14. The device of claim 13, wherein the structural features include a roughened surface of one or more of the first plate, the second plate, and the body, at the perimeter and within the one or more collection areas.

15. The device of claim 13, wherein the structural features comprise a series of uniformly spaced grooves traversing the body, the first plate, and the second plate, the grooves cooperating to form a series of posts that scrape skin cells from the subject's inner cheek.

16. The device of claim 9, wherein:
the first plate comprises a mouth portion on which the first bite area is disposed;
the second plate comprises a mouth portion on which the second bite area is disposed; and
the mount portion of the body, the mouth portion of the first plate, and the mouth portion of the second plate cooperate to provide the device with a conformal U-shape that fits within the subject's mouth.

17. The device of claim 16, wherein:
the first plate comprises a finger portion on which the first touch area is disposed, the finger portion integral with the mouth portion of the first plate and extending at least one inch proximally from the mouth portion of the first plate; and
the second plate comprises a finger portion on which the second touch area is disposed, the finger portion integral with the mouth portion of the second plate and extending at least one inch proximally from the mouth portion of the second plate.

18. The device of claim 17, wherein the handle portion of the body extends at least three inches proximally from the respective finger portions of the first and second plates.
